(19) United States
(12) Patent Application Publication
(10) Pub. No.: US 2022/0363929 A1
(43) Pub. Date: Nov. 17, 2022

(54) INKJET INK COMPOSITION

(71) Applicant: Hewlett-Packard Development Company, L.P., Spring, TX (US)

(72) Inventors: Kellie S. Dalby, Corvallis, OR (US); Raymond Adamic, Corvallis, OR (US); Garry Hinch, Corvallis, OR (US)

(21) Appl. No.: 17/763,538

(22) PCT Filed: Dec. 2, 2019
(86) PCT No.: PCT/US2019/063972

§ 371 Date: Mar. 24, 2022

(51) Int. Cl. C09D 11/38; C09D 11/322; C09D 11/328; C08K 3/36; C08K 9/06

(52) U.S. Cl. CPC C09D 11/38; C09D 11/322; C09D 11/328; C08K 3/36; C08K 9/06; C08K 2201/011

(57) ABSTRACT

An example of an inkjet ink composition includes an aqueous vehicle, a colorant dispersed or dissolved in the aqueous vehicle, silica nanoparticles dispersed in the aqueous vehicle, and modified silica nanoparticles dispersed in the aqueous vehicle. Each modified silica nanoparticle includes a silica core as well as a hydrophobic silane coupling agent attached to the silica core.

### BACKGROUND

In addition to home and office usage, inkjet technology has expanded to high-speed, commercial and industrial printing. Inkjet printing is a non-impact printing method that utilizes electronic signals to control and direct droplets or a stream of ink to be deposited onto media. Methods used in current inkjet technology make use of thermal ejection, piezoelectric pressure or oscillation onto the surface of the media to force the ink drops through small nozzles. Inkjet technology has grown to be a popular method for recording images on various media surfaces (e.g. paper), for numerous reasons; including low printer noise, capability of high-speed recording and multi-color recording.

### BRIEF DESCRIPTION OF THE DRAWINGS

Features of examples of the present disclosure will become apparent by reference to the following detailed description and drawings.

FIG. 1 is a flow diagram of a method of making an example of the thermal inkjet ink composition disclosed herein;

FIGS. 2A through 2C depict black and white reproduction of originally colored photographs of an example ink (FIG. 2A), a comparative example ink (FIG. 2B), and a control ink (FIG. 2C) applied on offset coated media;

FIG. 3 is a graph depicting the color saturation of an example ink and a control ink on three different plain papers at different print densities;

FIG. 4A and FIG. 4B depict black and white reproduction of originally colored photographs of an example ink (FIG. 4A) and a control ink (FIG. 4B) applied on offset coated media; and

FIG. 5A is a graph depicting the color saturation of an example ink and a control ink on an offset coated media at different print densities; and

FIG. 5B is a graph depicting the color saturation of an example ink and a control ink on a plain paper at different print densities.

### DETAILED DESCRIPTION

The composition of an ink affects the printability of the ink and the print characteristics of images formed with the ink. Ink performance is thus governed, at least in part, by adjusting ink components and amounts to improve printability and/or printed image characteristics. Altering an ink composition to improve one attribute of ink performance (e.g., printability) may deteriorate or compromise another attribute of the ink performance (e.g., color saturation, coalescence, durability, etc.). In an example, increasing the binder amount in an ink can improve the durability of a printed image; however, an increase in binder can also worsen the printability of the ink by increasing the viscosity, which can lead to clogged nozzles in the printhead, etc. In another example, gelators may be added to an ink composition to improve optical density and/or color saturation; however, gelators can increase the solids content, which can lead to agglomerate formation (i.e., amount of precipitates that have accumulated in a printhead nozzle during a set time period), which can adversely affect print reliability and printhead nozzle health.

Print media and print media components may also affect the print performance as well. The type of print media may affect the quality of the printed image, such as color saturation, dry times, and durability of the image. The print media and ink may have similar surface properties to take advantage of the “like attracts like” nature in chemistry. Thus, an ink may be formulated to achieve high image quality on a limited range of media, while trading off performance such as color saturation on other media. In particular, the same ink composition may form very different prints when printed on varying media, for example, on plain paper or on enhanced paper. As an example, an ink that spreads more and coalesces less on enhanced paper tends to penetrate more into plain paper, resulting in lower color saturation.

As used herein, “plain paper” refers to paper that has not been specially coated or designed for specialty uses (e.g., photo printing). Plain paper is composed of cellulose fibers and fillers. This is in contrast to an enhanced paper (described below), plain paper includes no additives that produce a chemical interaction with a pigment in an ink that is printed upon it. As used herein, “enhanced paper” refers to a paper that comprises cellulose fibers, fillers, and one or more additives that enhance print performance in some way. An example of the additive may be calcium chloride or another salt that reacts instantaneously with an anionic pigment present in an ink. This reaction then causes the pigment to precipitate out of the ink and fixes the pigment to the enhanced paper surface. In an example, the enhanced paper may be any standard paper that incorporates ColorLok® Technology (International Paper Co.). Both plain paper and enhanced paper are commercially available as a general office printer and/or copier papers, but as mentioned before, the enhanced paper incorporates the ColorLok® Technology. Examples of plain paper used herein include STAPLES® copy paper, Georgia-Pacific Spectrum Multipurpose paper (from Georgia-Pacific), and Hammermill Great White 30 (from Hammermill). Examples of enhanced paper used herein include HP® Multipurpose paper media with COLORLOK® technology (from HP Inc.) and STERLING® Ultra Gloss paper media (from Verso Corp.).

Disclosed herein is an ink composition that enables print reliability and consistent print performance attributes on both plain paper and enhanced paper. With this ink composition, a higher number of print media sources are available to produce quality prints. These attributes are due, in part, to a combination of modified silica particles and non-modified silica particles.

The modified silica particles include a silica (silicon dioxide) core and a silane coupling agent (SCA) attached thereto. The SCA is hydrophobic, and the ratio of silica to SCA is controlled to impart a desirable level of hydrophobicity to the modified silica particles. As illustrated in the examples disclosed herein, it has been found that the hydrophobic modified silica particles help to reduce coalescence on enhanced paper while maintaining or increasing color saturation on plain paper.

The non-modified silica nanoparticles interact with ink pigments to create a shear thinning network which maintains association with the pigments to improve color performance and saturation, especially on plain paper. More specifically, the non-modified silica nanoparticles may contribute to more colorant remaining on the media surface, thus resulting in an increase in color saturation on plain papers.

The combination of the modified silica particles and non-modified silica particles contributes to the versatility of the ink composition disclosed herein. These components and their respective amounts, without being bound to any theory, have shown to exhibit non-Newtonian properties that broaden the ink performance to produce quality prints independent of the components of the media that the ink is printed on.

Moreover, as illustrated in the examples set forth herein, the inkjet ink composition can be digitally jetted with a thermal inkjet printhead.

Throughout this disclosure, a weight percentage that is referred to as “wt % active” refers to the loading of an active component of a dispersion or other formulation that is present in the inkjet ink. For example, a pigment may be present in a water-based formulation (e.g., a stock solution or dispersion) before being incorporated into the inkjet ink. In this example, the wt % actives of the pigment accounts for the loading (as a weight percent) of the pigment that is present in the inkjet ink, and does not account for the weight of the other components (e.g., water, etc.) that are present in the formulation with the white pigment. The term “wt %,” without the term actives, refers to either i) the loading (in the inkjet ink or the pre-treatment composition) of a 100% active component that does not include other non-active components therein, or the loading (in the inkjet ink or the pre-treatment composition) of a material or component that is used “as is” and thus the wt % accounts for both active and non-active components.

Method for Making Modified Silica Nanoparticles

As mentioned, examples of the inkjet ink composition include modified silica nanoparticles.

The modified silica nanoparticles include a silica core. As such, the center of each modified nanoparticle includes silica. Silica molecules include a silicon atom chemically bonded to two oxygen atoms, and is also known as silicon dioxide, or SiO₂.

Suitable silicas that may be used for the core of the modified silica nanoparticles include anisotropic silica (e.g., elongated, covalently attached silica particles, such as PSM, which is commercially available from Nissan Chemical) or spherical silica dispersions (such as SNOWTEX® 30LH from Nissan Chemical). Other suitable commercially available silicas are sold under the tradename ORGANOSILICASOL™, which are organic solvent dispersed silica sols. In an example, the silica is anisotropic silica, spherical silica or a combination of anisotropic silica and spherical silica. Anisotropic silica dispersions have a higher aspect ratio compared to spherical silica.

The silica core may be a nanoparticle. In the examples disclosed herein, the silica nanoparticles have a particle size ranging from about 5 nm to about 200 nm. In another example, the silica nanoparticles have a particle size ranging from about 10 nm to about 150 nm, or from about 7 nm to about 100 nm. In still another example, the silica nanoparticles have a particle size ranging from about 5 nm to about 20 nm. In yet another example, the silica nanoparticles have a particle size ranging from about 10 nm to about 20 nm. The term “particle size”, as used herein, refers to the diameter of a spherical particle, or the average diameter of a non-spherical particle (i.e., the average of multiple diameters across the particle), or the volume-weighted mean diameter of a particle distribution.

As mentioned, the silica nanoparticles are modified with a silane coupling agent (SCA). Silane coupling agents are compounds whose molecules contain functional groups that bond with both organic and inorganic materials, and thus have an organic substitution that alters the physical interactions of treated substrates. In the examples disclosed herein, hydrophobic silane coupling agents have been found to enhance ink performance. As such, the silane coupling agents used herein have a hydrophobic organofunctional group, as well as hydrolyzable groups. The silane coupling agent structure can generally be represented as SiR¹R²R³R⁴, where from 1 to 3 of the 4 R groups is a hydrolyzable group (e.g., an alkoxy, a halogen, dimethylamine or another amine, oxime), and any remaining R group(s) can be any mixture of functional groups, as long as 1 of them is a hydrophobic organofunctional group. In some examples, the remaining R group(s) are all hydrophobic organofunctional groups (which can be the same or different). In other examples, at least 1 or 2 of the remaining R group(s) is another functional group, such as H, a hydroxyl (—OH), an alkyl group (e.g., a C₁ to C₆ alkyl), etc. Some examples of the hydrophobic silicon coupling agents are

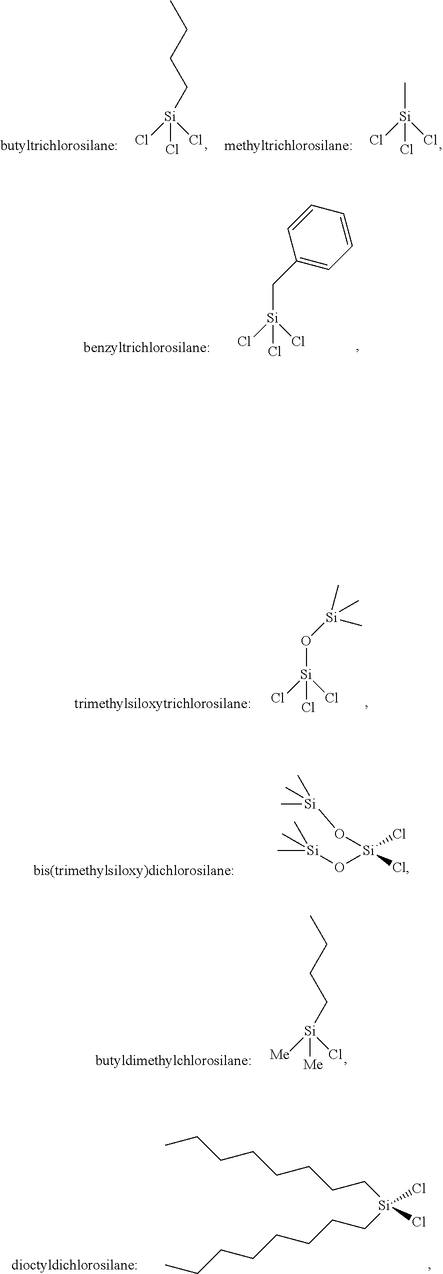

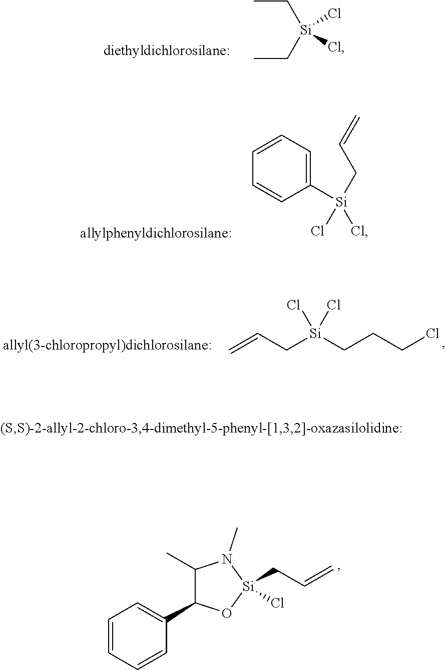

and combinations thereof.

In an example, the modified silica particles may be made through a reaction process referred to herein as silica functionalization. Silica functionalization introduces the silane coupling agent onto the surface of the silica nanoparticle. More specifically, the silane coupling agent bonds to the silica nanoparticle, e.g., through the hydrolyzable group(s). For example, the alkoxy or halogen group(s) may react with SiOH group(s) to form Si—O—Si bonds.

The silica nanoparticles may be dispersed in a non-aqueous liquid carrier. A non-aqueous liquid carrier may be desirable because additional hydrolysis reactions do not take place at the surface of the silica nanoparticles in this type of environment. As such, the degree of the reaction between the silica and the silane coupling agent can be better controlled than, for example, when a similar reaction takes place in an aqueous environment. Examples of suitable non-aqueous liquid carriers include toluene, dichloromethane, isopropanol, and methanol.

The silica nanoparticles may be added as dry particles to the non-aqueous liquid carrier, or they may be pre-dispersed in another liquid carrier. For example, silica nanoparticles may be dispersed in isopropyl alcohol or another solvent. This dispersion can be diluted with the non-aqueous liquid carrier to obtain a dispersion with the desirable silica nanoparticle concentration.

The concentration of the silica nanoparticles in the non-aqueous liquid carrier ranges from about 1 wt % active to about 10 wt % active. In an example, the concentration of the silica nanoparticles in the non-aqueous liquid carrier ranges is about 5 wt % active.

The SCA that is selected is then introduced to the silica nanoparticle to form a mixture. The ratio of the silane coupling agent to the silica nanoparticles in the mixture is a weight ratio ranging from 1:4 up to 1:40. In another example, the weight ratio of the silane coupling agent to the silica nanoparticles in the mixture ranges from 1:4 up to 1:20. In still another example, the weight ratio of the silane coupling agent to the silica nanoparticles in the mixture ranges from 1:20 up to 1:40. It has been found that these weight ratios impart a desirable amount of hydrophobicity to the modified silica nanoparticles to reduce coalescence on enhanced paper, without interfering with the shear thinning properties of the non-modified silica particles.

The mixture may be heated to a predetermined temperature and allowed to react for a predetermined time. During this time, the mixture may also be stirred. The temperature and time for the reaction may depend, in part, upon the silane coupling agent that is used. The reaction temperature may range from about 60° C. to about 110° C., and the reaction time may range from about 5 hours to about 15 hours. In one example, the mixture is stirred at 80° C. for about 10 hours. During the reaction, the SCA bonds to the silica nanoparticle core. The modified silica nanoparticles are then washed and dried to remove any organic solvents and unreacted silane coupling agent, and isolate the modified nanoparticles.

The modified silica nanoparticles may be incorporated into a stock modified silica nanoparticle (MSN) dispersion before being mixed with an ink vehicle to form the inkjet ink composition. The stock MSN dispersion may be prepared by introducing the dried modified silica nanoparticles into a solvent to yield a dispersion having a predetermined weight percentage of the modified silica nanoparticles. The stock MSN dispersion includes from about 10 wt % to about 40 wt % of the modified silica nanoparticles. In one example, the stock MSN dispersion includes from about 15 wt % to about 35 wt % of the modified silica nanoparticles. In one specific example, the stock MSN dispersion includes about 30 wt % of the modified silica nanoparticles.

The solvent of the stock MSN dispersion may depend, in part, on the ink vehicle in which the stock MSN dispersion is to be added. The ink vehicle is aqueous, and thus the solvent of the stock MSN dispersion may include water. In some instances, water alone is used. In other instances, a mixture water and 2-pyrrolidone is used. The solvent mixture may depend upon the modified silica nanoparticles and solvent(s) in which they can be dispersed, as well as the ink formulation to which the modified silica nanoparticles are to be added. The solvent mixture may be desirable for the stock MSN dispersion when higher amounts of the modified silica nanoparticles are included.

When the modified silica nanoparticles are added to the solvent(s), the pH of the dispersion may be modified to be within the range of 8.5 to 10, or from 9.0 and 9.5. In some instances, a base (e.g., KOH, NaOH, etc.) may be used to adjust the pH. In one example, a 10 wt % KOH solution is used. The dispersion may be then be sonicated at a power level and for a time that are suitable for generating a stable dispersion. In some instances, sonication is performed for up to 5 minutes (e.g., for 1 minute, for 1.5 minutes, etc.) using a probe sonicator at a power ranging from about 10 W to about 20 W. The time for sonication may depend, in part, upon the batch size and the power used, and thus may be longer than 5 minutes. The pH adjustment and sonication may be repeated until the pH remains within the provided range after sonication.

The dispersion may be filtered prior to be incorporated into the inkjet ink composition.

Inkjet Ink Composition

The inkjet ink composition described herein may be comprised of an aqueous (ink) vehicle, a colorant dispersed or dissolved in the aqueous vehicle, silica nanoparticles, and modified silica nanoparticles. In some instances, the inkjet ink composition consists of these components, without any other components.

Modified Silica Nanoparticles

As described herein, the modified silica nanoparticles include a silica core with a hydrophobic silane coupling agent attached to that core. The modified silica nanoparticles may be prepared as described herein, by attaching the hydrophobic silane coupling agent to the silica core.

The modified silica nanoparticles may be incorporated into the inkjet ink composition in the form of the stock MSN dispersion. In these examples, the stock MSN dispersion may be added to the ink vehicle or diluted with the ink vehicle so that the desired amount of modified silica nanoparticles is incorporated into the inkjet ink. In other examples, the modified silica nanoparticles may be incorporated into the inkjet composition in the form of a powder. In these examples, the solid modified silica nanoparticles may be added to the ink vehicle in the desired amount, and sonication may be used to achieve a stable dispersion.

The modified silica nanoparticles are present in the inkjet ink composition in an amount ranging from about 0.5 wt % active to about 6 wt % active based on the total weight of the inkjet ink composition. In other examples, the modified silica nanoparticles are present in the inkjet ink composition in an amount ranging from about 1 wt % active to about 4 wt % active from about 3 wt % active to about 6 wt % active based on the total weight of the inkjet ink composition. It is to be understood that these amounts account for the weight percent of the modified silica nanoparticles, and do not account for any solvent(s) that may be added along with the modified silica nanoparticles (e.g., when introduced as part of the stock MNP dispersion).

The hydrophobic portion of the modified silica nanoparticles help to reduce coalescence on enhanced paper.

Non-Modified Silica Nanoparticles

The non-modified silica nanoparticles are silica (i.e., silicon dioxide) particles that do not have a silane coupling agent attached thereto. Suitable silicas that may be used as the non-modified silica nanoparticles include any of those set forth herein for the core of the modified silica nanoparticles.

In one example, the particle size of the non-modified silica nanoparticles may range from about 5 nm to about 50 nm. In another example, the particle size of the non-modified silica nanoparticles may range from about 10 nm to about 25 nm. In still another example, the particle size of the non-modified silica nanoparticles may range from about 5 nm to about 20 nm.

The modified silica nanoparticles may be incorporated into the inkjet ink composition in the form of a dispersion (e.g., dispersed in a solvent) or as a dry powder.

In the examples disclosed herein, the non-modified silica nanoparticles may be present in the inkjet ink composition in an amount ranging from 0.5 wt % to 6 wt % based on the total weight of the inkjet ink composition. In one example, the non-modified silica nanoparticles can be present in an amount ranging from about 3 wt % to about 6 wt %, based on the total weight of the inkjet ink composition. In another example, the non-modified silica nanoparticles can be present in an amount ranging from about 1 wt % to about 2 wt %, based on the total weight of the inkjet ink composition. It is to be understood that these amounts account for the weight percent of the non-modified silica nanoparticles, and do not account for any solvent(s) that may be added along with the non-modified silica nanoparticles (e.g., when introduced as part of a dispersion).

The non-modified silica nanoparticles can interact with ink pigments to create a shear thinning network which maintains association with the pigments to improve color performance, especially on plain paper.

Colorant

The inkjet ink composition also includes a colorant. The colorant in the inkjet ink may be a pigment, a dye, or a combination thereof. Whether a pigment and/or a dye is included, the colorant can be any of a number of primary or secondary colors, or black or white. As specific examples, the colorant may be any color, including, as examples, a cyan pigment and/or dye, a magenta pigment and/or dye, a yellow pigment and/or dye, a black pigment and/or dye, a violet pigment and/or dye, a green pigment and/or dye, a brown pigment and/or dye, an orange pigment and/or dye, a purple pigment and/or dye, a white pigment and/or dye, or combinations thereof. In one example, the colorant includes a magenta pigment and a magenta dye.

In some examples, the colorant may be a dye. As used herein, “dye” refers to compounds or molecules that absorb electromagnetic radiation or certain wavelengths thereof. Dyes can impart a visible color to the inkjet ink if the dyes absorb wavelengths in the visible spectrum.

The dye (prior to being incorporated into the ink formulation), may be dispersed in water alone or in combination with an additional water soluble or water miscible co-solvent. It is to be understood however, that the liquid components of the dye dispersion become part of the ink vehicle in the inkjet ink composition.

In some examples, the dye may be present in an amount ranging from about 0.5 wt % active to about 15 wt % active based on a total weight of the inkjet ink composition. In one example, the dye may be present in an amount ranging from about 1 wt % active to about 10 wt % active. In another example, the dye may be present in an amount ranging from about 5 wt % active to about 10 wt % active.

The dye can be nonionic, cationic, anionic, or a mixture of nonionic, cationic, and/or anionic dyes. The dye can be a hydrophilic anionic dye, a direct dye, a reactive dye, a polymer dye or an oil soluble dye. Specific examples of dyes that may be used include Sulforhodamine B, Acid Blue 113, Acid Blue 29, Acid Red 4, Rose Bengal, Acid Yellow 17, Acid Yellow 29, Acid Yellow 42, Acridine Yellow G, Acid Yellow 23, Acid Blue 9, Nitro Blue Tetrazolium Chloride Monohydrate or Nitro BT, Rhodamine 6G, Rhodamine 123, Rhodamine B, Rhodamine B Isocyanate, Safranine O, Azure B, and Azure B Eosinate, which are available from Sigma-Aldrich Chemical Company (St. Louis, Mo.). Examples of anionic, water-soluble dyes include Direct Yellow 132, Direct Blue 199, Magenta 377 (available from Ilford AG, Switzerland), alone or together with Acid Red 52. Examples of water-insoluble dyes include azo, xanthene, methine, polymethine, and anthraquinone dyes. Specific examples of water-insoluble dyes include ORASOL® Blue GN, ORASOL® Pink, and ORASOL® Yellow dyes available from BASF Corp. Black dyes may include Direct Black 154, Direct Black 168, Fast Black 2, Direct Black 171, Direct Black 19, Acid Black 1, Acid Black 191, Mobay Black SP, and Acid Black 2.

In some examples, the colorant may be a pigment. As used herein, “pigment” may include charge dispersed (i.e., self-dispersed) organic or inorganic pigment colorants. The following examples of suitable pigments can be charged and thus made self-dispersible.

Examples of suitable blue or cyan organic pigments include C.I. Pigment Blue 1, C.I. Pigment Blue 2, C.I. Pigment Blue 3, C.I. Pigment Blue 15, Pigment Blue 15:3, C.I. Pigment Blue 15:34, C.I. Pigment Blue 15:4, C.I. Pigment Blue 16, C.I. Pigment Blue 18, C.I. Pigment Blue 22, C.I. Pigment Blue 25, C.I. Pigment Blue 60, C.I. Pigment Blue 65, C.I. Pigment Blue 66, C.I. Vat Blue 4, and C.I. Vat Blue 60.

Examples of suitable magenta, red, or violet organic pigments include C.I. Pigment Red 1, C.I. Pigment Red 2, C.I. Pigment Red 3, C.I. Pigment Red 4, C.I. Pigment Red 5, C.I. Pigment Red 6, C.I. Pigment Red 7, C.I. Pigment Red 8, C.I. Pigment Red 9, C.I. Pigment Red 10, C.I. Pigment Red 11, C.I. Pigment Red 12, C.I. Pigment Red 14, C.I. Pigment Red 15, C.I. Pigment Red 16, C.I. Pigment Red 17, C.I. Pigment Red 18, C.I. Pigment Red 19, C.I. Pigment Red 21, C.I. Pigment Red 22, C.I. Pigment Red 23, C.I. Pigment Red 30, C.I. Pigment Red 31, C.I. Pigment Red 32, C.I. Pigment Red 37, C.I. Pigment Red 38, C.I. Pigment Red 40, C.I. Pigment Red 41, C.I. Pigment Red 42, C.I. Pigment Red 48(Ca), C.I. Pigment Red 48(Mn), C.I. Pigment Red 57(Ca), C.I. Pigment Red 57:1, C.I. Pigment Red 88, C.I. Pigment Red 112, C.I. Pigment Red 114, C.I. Pigment Red 122, C.I. Pigment Red 123, C.I. Pigment Red 144, C.I. Pigment Red 146, C.I. Pigment Red 149, C.I. Pigment Red 150, C.I. Pigment Red 166, C.I. Pigment Red 168, C.I. Pigment Red 170, C.I. Pigment Red 171, C.I. Pigment Red 175, C.I. Pigment Red 176, C.I. Pigment Red 177, C.I. Pigment Red 178, C.I. Pigment Red 179, C.I. Pigment Red 184, C.I. Pigment Red 185, C.I. Pigment Red 187, C.I. Pigment Red 202, C.I. Pigment Red 209, C.I. Pigment Red 219, C.I. Pigment Red 224, C.I. Pigment Red 245, C.I. Pigment Red 286, C.I. Pigment Violet 19, C.I. Pigment Violet 23, C.I. Pigment Violet 32, C.I. Pigment Violet 33, C.I. Pigment Violet 36, C.I. Pigment Violet 38, C.I. Pigment Violet 43, and C.I. Pigment Violet 50.

Examples of suitable yellow organic pigments include C.I. Pigment Yellow 1, C.I. Pigment Yellow 2, C.I. Pigment Yellow 3, C.I. Pigment Yellow 4, C.I. Pigment Yellow 5, C.I. Pigment Yellow 6, C.I. Pigment Yellow 7, C.I. Pigment Yellow 10, C.I. Pigment Yellow 11, C.I. Pigment Yellow 12, C.I. Pigment Yellow 13, C.I. Pigment Yellow 14, C.I. Pigment Yellow 16, C.I. Pigment Yellow 17, C.I. Pigment Yellow 24, C.I. Pigment Yellow 34, C.I. Pigment Yellow 35, C.I. Pigment Yellow 37, C.I. Pigment Yellow 53, C.I. Pigment Yellow 55, C.I. Pigment Yellow 65, C.I. Pigment Yellow 73, C.I. Pigment Yellow 74, C.I. Pigment Yellow 75, C.I. Pigment Yellow 77, C.I. Pigment Yellow 81, C.I. Pigment Yellow 83, C.I. Pigment Yellow 93, C.I. Pigment Yellow 94, C.I. Pigment Yellow 95, C.I. Pigment Yellow 97, C.I. Pigment Yellow 98, C.I. Pigment Yellow 99, C.I. Pigment Yellow 108, C.I. Pigment Yellow 109, C.I. Pigment Yellow 110, C.I. Pigment Yellow 113, C.I. Pigment Yellow 114, C.I. Pigment Yellow 117, C.I. Pigment Yellow 120, C.I. Pigment Yellow 122, C.I. Pigment Yellow 124, C.I. Pigment Yellow 128, C.I. Pigment Yellow 129, C.I. Pigment Yellow 133, C.I. Pigment Yellow 138, C.I. Pigment Yellow 139, C.I. Pigment Yellow 147, C.I. Pigment Yellow 151, C.I. Pigment Yellow 153, C.I. Pigment Yellow 154, C.I. Pigment Yellow 167, C.I. Pigment Yellow 172, C.I. Pigment Yellow 180, and C.I. Pigment Yellow 185.

Carbon black may be a suitable inorganic black pigment. Examples of carbon black pigments include those manufactured by Mitsubishi Chemical Corporation, Japan (such as, e.g., carbon black No. 2300, No. 900, MCF88, No. 33, No. 40, No. 45, No. 52, MA7, MA8, MA100, and No. 2200B); various carbon black pigments of the RAVEN® series manufactured by Columbian Chemicals Company, Marietta, Ga., (such as, e.g., RAVEN® 5750, RAVEN® 5250, RAVEN® 5000, RAVEN® 3500, RAVEN® 1255, and RAVEN® 700); various carbon black pigments of the REGAL® series, the MOGUL® series, or the MONARCH® series manufactured by Cabot Corporation, Boston, Mass., (such as, e.g., REGAL® 400R, REGAL® 330R, REGAL® 660R, MOGUL® E, MOGUL® L, AND ELFTEX® 410); and various black pigments manufactured by Evonik Degussa Orion Corporation, Parsippany, N.J., (such as, e.g., Color Black FW1, Color Black FW2, Color Black FW2V, Color Black FW18, Color Black FW200, Color Black S150, Color Black S160, Color Black S170, PRINTEX® 35, PRINTEX® U, PRINTEX® V, PRINTEX® 140U, Special Black 5, Special Black 4A, and Special Black 4). An example of an organic black pigment includes aniline black, such as C.I. Pigment Black 1.

Some examples of green organic pigments include C.I. Pigment Green 1, C.I. Pigment Green 2, C.I. Pigment Green 4, C.I. Pigment Green 7, C.I. Pigment Green 8, C.I. Pigment Green 10, C.I. Pigment Green 36, and C.I. Pigment Green 45.

Examples of brown organic pigments include C.I. Pigment Brown 1, C.I. Pigment Brown 5, C.I. Pigment Brown 22, C.I. Pigment Brown 23, C.I. Pigment Brown 25, C.I. Pigment Brown 41, and C.I. Pigment Brown 42.

Some examples of orange organic pigments include C.I. Pigment Orange 1, C.I. Pigment Orange 2, C.I. Pigment Orange 5, C.I. Pigment Orange 7, C.I. Pigment Orange 13, C.I. Pigment Orange 15, C.I. Pigment Orange 16, C.I. Pigment Orange 17, C.I. Pigment Orange 19, C.I. Pigment Orange 24, C.I. Pigment Orange 34, C.I. Pigment Orange 36, C.I. Pigment Orange 38, C.I. Pigment Orange 40, C.I. Pigment Orange 43, and C.I. Pigment Orange 66.

The average particle size of the pigments may range anywhere from about 50 nm to about 200 nm. In an example, the average particle size ranges from about 80 nm to about 150 nm.

The pigment may be incorporated into the inkjet ink composition in the form of a pigment dispersion, in which the pigment is self-dispersed. In the examples disclosed herein, the pigment may be present in the ink composition in an amount ranging from about 2 wt % actives to about 5 wt % actives based on the total weight of the inkjet ink composition. In another example, the pigment amount ranges from about 4 wt % actives to about 5 wt % actives based on the total weight of the inkjet ink composition. When the pigment is added in the form of a pigment dispersion, the amount of dispersion may be selected so that from about 2 wt % actives (i.e., pigment) to about 5 wt % actives is incorporated into the thermal inkjet ink composition. It is to be understood that the active percentage accounts for the pigment amount, and does not reflect the amount of other dispersion components that may be included.

Ink Vehicle

The “ink vehicle” as described herein may refer to the liquid component to which the colorant, the silica nanoparticles, and the modified silica nanoparticles are added to form the inkjet ink composition. In some examples the ink vehicle may contain water, a co-solvent, and a surfactant. In other examples, the ink vehicle may also contain a sugar alcohol and/or an organic salt dissolved or dispersed therein. In still other examples, the inkjet ink includes an additive selected from the group consisting of an anti-kogation agent, a humectant, a biocide, a pH adjuster, sequestering agents, binder, and a combination thereof.

The co-solvent in the ink vehicle may be selected to be miscible with water. One example of a suitable co-solvent is 2-pyrrolidone (2P). Other examples of suitable co-solvents include 1-(2-hydroxyethyl)-2-pyrrolidone (HE2P), 2-ethyl-2-hydroxymethyl-1,3-propanediol) (EHPD), tetraethylene glycol (TEG), combinations thereof, or combinations of any of these with 2P. Other co-solvents may also be included that increase the solubility of a poorly soluble compound. In this example, the co-solvents may be used to increase the dispersability of the modified silica nanoparticles within the ink vehicle. The modified silica nanoparticles may be poorly-soluble in the aqueous ink composition due to the hydrophobic silane coupling agent. Therefore, additional co-solvents may be used to help disperse the nanoparticles at least substantially evenly throughout the ink vehicle. Examples of these co-solvents include alcohols, such as methanol or ethanol, propylene glycol, glycerine, or polyethylene glycol.

Whether a single co-solvent or a combination of co-solvents is used, the total amount of the co-solvent(s) present in the inkjet ink composition ranges from about 5 wt % to about 40 wt % of the total weight of the inkjet ink composition. In some examples, the co-solvent amount ranges from about 10 wt % to about 35 wt %, or from about 5 wt % to about 25 wt %.

Examples of suitable surfactants include sodium dodecyl sulfate (SDS), a linear, N-alkyl-2-pyrrolidone (e.g., SURFADONE™ LP-100 from Ashland Inc.), a self-emulsifiable, nonionic wetting agent based on acetylenic diol chemistry (e.g., SURFYNOL® SEF from Evonik Ind.), a nonionic fluorosurfactant (e.g., CAPSTONE® fluorosurfactants, such as CAPSTONE® FS-35, from DuPont, previously known as ZONYL FSO), and combinations thereof. In other examples, the surfactant is an ethoxylated low-foam wetting agent (e.g., SURFYNOL® 440 or SURFYNOL® CT-111 from Evonik Ind.) or an ethoxylated wetting agent and molecular defoamer (e.g., SURFYNOL® 420 from Evonik Ind.). Still other suitable surfactants include non-ionic wetting agents and molecular defoamers (e.g., SURFYNOL® 104E from Evonik Ind.) or water-soluble, non-ionic surfactants (e.g., TERGITOL™ TMN-6, TERGITOL™ 15-S-7, or TERGITOL™ 15-S-9 (a secondary alcohol ethoxylate) from The Dow Chemical Company or TECO® Wet 510 (polyether siloxane) available from Evonik Ind.). In some examples, it may be desirable to utilize a surfactant having a hydrophilic-lipophilic balance (HLB) less than 10.

Whether a single surfactant is used or a combination of surfactants is used, the total amount of surfactant(s) in the inkjet ink composition may range from about 0.01 wt % actives to about 10 wt % actives based on the total weight of the thermal inkjet ink composition. In an example, the total amount of surfactant(s) in the inkjet ink composition ranges from about 0.1 wt % actives to about 1 wt % actives of the total weight of the inkjet ink composition.

The ink vehicle may contain a sugar alcohol, which can be any type of chain or cyclic sugar alcohol. In one example, the sugar alcohol can have the formula: H(HCHO)n+1H, where n is at least 3. Such sugar alcohols can include erythritol (4-carbon), threitol (4-carbon), arabitol (5-carbon), xylitol (5-carbon), ribitol (5-carbon), mannitol (6-carbon), sorbitol (6-carbon), galactitol (6-carbon), fucitol (6-carbon), iditol (6-carbon), inositol (6-carbon; a cyclic sugar alcohol), volemitol (7-carbon), isomalt (12-carbon), maltitol (12-carbon), lactitol (12-carbon), and mixtures thereof. In one example, the sugar alcohol can be a 5-carbon sugar alcohol. In another example, the sugar alcohol can be a 6-carbon sugar alcohol. In still another example, the sugar alcohol may be selected from the group consisting of sorbitol, xylitol, mannitol, erythritol, and combinations thereof. Whether a single sugar alcohol is used or a combination of sugar alcohols is used, the total amount of sugar alcohol(s) in the inkjet ink composition may range from about 0.5 wt % to about 15 wt % based on the total weight of the thermal inkjet ink composition. Sugar alcohol levels higher than 15 wt % can cause a printability issue from a thermal inkjet printhead due to increased viscosity. In one example, each individual sugar alcohol is present in an amount ranging from 0.5 wt % up to about 5 wt % based on the total weight of the inkjet ink composition. The use of a sugar alcohol can provide improved reliability, excellent curl and rub/scratch resistance.

The ink vehicle may also contain an organic acid. Examples of the organic acid may include carboxylic acids, sulfonic acids, citric acids, acetic acids, or any other organic acid, or combinations thereof. In one example, the acid is phthalic acid, which is an aromatic dicarboxylic acid.

In an example, the organic acid(s) is/are present in a total amount ranging from about 0.01 wt % actives to about 1 wt % actives based on the total weight of the inkjet ink composition. In another example, the organic acid(s) may be present in an amount ranging from about 0.05 wt % actives to about 0.5 wt % actives based on the total weight of the inkjet ink composition.

At the ink pH, the organic acid may be in salt form. The salt further contributes to the structure of the ink. A salt can act to shield the electrostatic repulsion between pigment particles and permit the van der Waals interactions to increase, thereby forming a stronger attractive potential and resulting in a structured network by providing elastic content to a predominantly fluidic system. These structured systems show non-Newtonian flow behavior, thus providing useful characteristics for implementation in an inkjet ink because of their ability to shear thin or thermal thin (in the case of thermal inkjet inks) for jetting. Once jetted, this feature allows the jetted drops to become more elastic-, mass-, or gel-like when they strike the media surface. These characteristics can also provide improved media attributes, such as colorant holdout on the surface of plain paper. Therefore, the role of the organic acid can impact both the jettability of the inkjet ink as well as the response after jetting.

As mentioned, some examples of the ink vehicle include one or more additives.

In some examples, the inkjet ink composition includes an anti-kogation agent. Kogation refers to the deposit of dried ink on a heating element of a thermal inkjet printhead. Anti-kogation agent(s) is/are included in thermal inkjet ink formulations to assist in preventing the buildup of kogation. Examples of suitable anti-kogation agents include oleth-3-phosphate (commercially available as CRODAFOS™ O3A or CRODAFOS™ N-3 acid) or dextran 500k. Other suitable examples of the anti-kogation agents include CRODAF™ HCE (phosphate-ester from Croda Int.), CRODAFOS® N10 (oleth-10-phosphate from Croda Int.), or DISPERSOGEN® LFH (polymeric dispersing agent with aromatic anchoring groups, acid form, anionic, from Clariant), etc.

The anti-kogation agent may be present in the inkjet ink composition in an amount ranging from about 0.01 wt % actives to about 1 wt % actives of the total weight of the inkjet ink composition. In another example, the anti-kogation agent may be present in the inkjet ink composition in an amount ranging from about 0.01 wt % actives to about 0.1 wt % actives of the total weight of the inkjet ink composition. In the examples disclosed herein, the anti-kogation agent may improve the jettability of the inkjet ink, for example, when jetted from a thermal inkjet printhead.

The inkjet ink composition may also include humectant(s). An example of a suitable humectant is ethoxylated glycerin having the following formula:

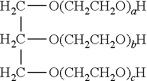

in which the total of a+b+c ranges from about 5 to about 60, or in other examples, from about 20 to about 30. An example of the ethoxylated glycerin is LIPONIC® EG-1 (LEG-1, glycereth-26, a+b+c=26, available from Lipo Chemicals).

In an example, the total amount of the humectant(s) present in the inkjet ink composition ranges from about 1 wt % actives to about 1.5 wt % actives, based on the total weight of the inkjet ink composition. In another example, the total amount of the humectant(s) present in the inkjet ink composition ranges from about 1 wt % actives to about 1.25 wt % actives, based on the total weight of the inkjet ink composition.

The inkjet ink composition may also include biocides (i.e., fungicides, anti-microbials, etc.). Example biocides may include the NUOSEPT™ (Troy Corp.), UCARCIDE™ (Dow Chemical Co.), ACTICIDE® B20 (Thor Chemicals), ACTICIDE® M20 (Thor Chemicals), ACTICIDE® MBL (blends of 2-methyl-4-isothiazolin-3-one (MIT), 1,2-benzisothiazolin-3-one (BIT) and Bronopol) (Thor Chemicals), AXIDE™ (Planet Chemical), NIPACIDE™ (Clariant), blends of 5-chloro-2-methyl-4-isothiazolin-3-one (CIT or CMIT) and MIT under the tradename KATHON™ (Dow Chemical Co.), and combinations thereof. Examples of suitable biocides include an aqueous solution of 1,2-benzisothiazolin-3-one (e.g., PROXEL® GXL from Arch Chemicals, Inc.), quaternary ammonium compounds (e.g., BARDAC® 2250 and 2280, BARQUAT® 50-65B, and CARBOQUAT® 250-T, all from Lonza Ltd. Corp.), and an aqueous solution of methylisothiazolone (e.g., KORDEK® MLX from Dow Chemical Co.).

In an example, the inkjet ink composition may include a total amount of biocides that ranges from about 0.05 wt % actives to about 1 wt % actives, based on a total weight of the inkjet ink composition.

The inkjet ink composition disclosed herein may have a pH ranging from about 7 to about 10, and pH adjuster(s) may be added to the inkjet ink composition to counteract any slight pH drop that may occur over time. Examples of suitable pH adjusters include metal hydroxide bases, such as sodium hydroxide (NaOH), potassium hydroxide (KOH), etc. In an example, the total amount of pH adjuster(s) in the inkjet ink composition ranges from greater than 0 wt % actives to about 0.1 wt % actives (with respect to the total weight of the inkjet ink composition).

Sequestering agents (or chelating agents) may be included in the inkjet ink composition to eliminate the deleterious effects of heavy metal impurities. Examples of sequestering agents include disodium ethylenediaminetetraacetic acid (EDTA-Na), ethylene diamine tetra acetic acid (EDTA), and methylglycinediacetic acid (e.g., TRILON® M from BASF Corp.). Whether a single sequestering agent is used or a combination of sequestering agents is used, the total amount of sequestering agent(s) in the inkjet ink composition may range from greater than 0 wt % actives to about 2 wt % actives based on the total weight of the inkjet ink composition.

The inkjet ink composition may also include a binder. Example binders may include a polyurethane binder, a styrene acrylic binder, or the like. In an example, the inkjet ink composition may include a total amount of binder up to about 1 wt % actives based on the total weight of the inkjet ink composition. In another example, the binder amount ranges from greater than 0 wt % actives to about 0.6 wt % actives based on the total weight of the inkjet ink composition.

The balance of the inkjet ink composition is water. As such, the amount of water included may vary, depending upon the amounts of the other inkjet ink components. As examples, thermal inkjet compositions may include more water than piezoelectric inkjet compositions. In an example, the water is deionized water.

The inkjet ink composition may be prepared by first preparing the modified silica nanoparticles as described herein, and then mixing together, the ink vehicle, the colorant, the modified silica nanoparticles, and the non-modified silica nanoparticles.

Printing Kit

An inkjet printing kit includes a recording medium; and an inkjet ink composition, including: an aqueous vehicle; a colorant dispersed or dissolved in the aqueous vehicle; silica nanoparticles dispersed in the aqueous vehicle; and modified silica nanoparticles dispersed in the aqueous vehicle, each modified silica nanoparticle including: a silica core; and a hydrophobic silane coupling agent attached to the silica.

In an example, the recording medium in the printing kit is enhanced paper or plain paper. As mentioned herein, the enhanced paper includes an additive that produces a chemical interaction with the pigment in the inkjet ink composition printed thereon, and the plain paper excludes an additive that produces a chemical interaction with the pigment in the inkjet ink composition that is printed thereon.

Any example of the inkjet ink composition disclosed herein may be used in the kit. In one example, the inkjet ink composition in the printing kit is a magenta inkjet ink.

It is to be understood that the components of the printing kit may be maintained separately until used together in examples of the printing method disclosed herein.

Printing Method

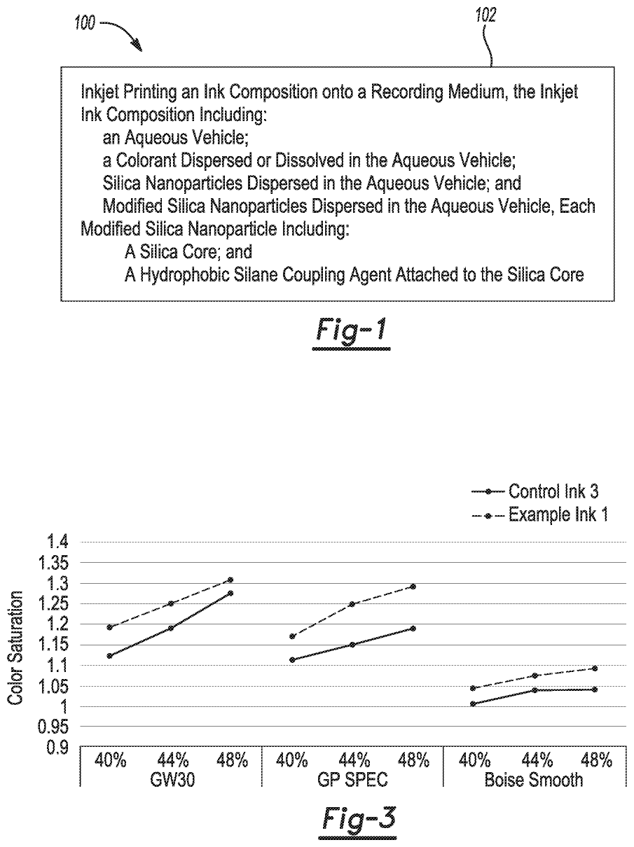

FIG. 1 depicts an example of the printing method 100. As shown in FIG. 1, an example of the printing method 100 comprises: inkjet printing an inkjet ink composition onto a recording medium, the inkjet ink composition including: an aqueous vehicle; a colorant dispersed or dissolved in the aqueous vehicle; silica nanoparticles dispersed in the aqueous vehicle; and modified silica nanoparticles dispersed in the aqueous vehicle, each modified silica nanoparticle including a silica core, and a hydrophobic silane coupling agent attached to the silica core (reference numeral 102).

It is to be understood that any example of the inkjet ink composition disclosed herein may be used in the examples of the method 100.

It is also to be understood that any example of the substrates may be used in the examples of the method 100.

In some examples, multiple inkjet ink compositions may be ejected onto the substrate. As an example, a combination of two or more inkjet ink compositions selected from the group consisting of a cyan ink, a magenta ink, a yellow ink, and a black ink may be ejected onto the substrate. In other examples, a single aqueous inkjet ink may be ejected onto the substrate.

The inkjet ink composition(s) may be ejected onto the substrate using any suitable applicator, such as a thermal inkjet printhead, a piezoelectric printhead, a continuous inkjet printhead, etc. The applicator may eject the inkjet ink composition(s) in a single pass or in multiple passes. As an example of single pass printing, the cartridge(s) of an inkjet printer deposit the desired amount of the inkjet ink composition(s) during the same pass of the cartridge(s) across the substrate. In other examples, the cartridge(s) of an inkjet printer deposit the desired amount of the inkjet ink composition(s) over several passes of the cartridge(s) across the substrate.

When the inkjet ink composition(s) is/are ejected on the substrate, the inkjet ink composition(s) sufficiently wet(s) the substrate. In some examples, coalescence of the inkjet ink composition(s) on enhanced paper substrate may be reduced or eliminated.

To further illustrate the present disclosure, examples are given herein. It is to be understood that these examples are provided for illustrative purposes and are not to be construed as limiting the scope of the present disclosure.

### EXAMPLES

### Example 1

Hydrophobically-Modified and Hydrophilically-Modified Silica nanoparticles were prepared. A hydrophobic silane coupling agent (Benzyltrichlorosilane) was used to prepare the hydrophobically-modified silica nanoparticles, and a silane coupling agent that is more hydrophilic than Benzyltrichlorosilane, namely (2-(4-Chlorosulfonylphenyl)ethyltrichlorosilane), was used to prepare the hydrophilically-modified silica nanoparticles.

Two silica dispersions in isopropyl alcohol were used. The average particle size of the silica in the dispersions ranged from 10 nm to 20 nm. The dispersions were respectively diluted with toluene until solutions with 5 wt % silica were achieved.

Benzyltrichlorosilane (the hydrophobic silane coupling agent) was added to one of the silica/toluene solutions at a ratio of 1 SCA:40 silica nanoparticles, and was stirred at 80° C. for 10 hours. The solids from this mixture were collected and washed with hexanes yielding hydrophobically-modified silica nanoparticles. The hydrophobically-modified silica nanoparticle solids were allowed to dry under vacuum at 100° C. overnight to remove any residual organic solvents.

A hydrophobic silica dispersion (referred to as “hydrophobic silica dispersion A”) was prepared by mixing the hydrophobically-modified silica nanoparticle solids in 50:50 solvent mixture of water:2 pyrrolidone. The final dispersion included about 30 wt % of the hydrophobically-modified silica nanoparticle solids.

2-(4-Chlorosulfonylphenyl)ethyltrichlorosilane (the hydrophilic silane coupling agent) was added to the other of the silica/toluene solutions at a ratio of 1 SCA:40 silica nanoparticles, and was stirred at 80° C. for 10 hours. The solids from this mixture were collected and washed with hexanes yielding hydrophilically-modified silica nanoparticles. The hydrophilically-modified silica nanoparticle solids were allowed to dry under vacuum at 100° C. overnight to remove any residual organic solvents.

A hydrophilic silica dispersion was prepared by mixing the hydrophilically-modified silica nanoparticle solids in water. The final dispersion included about 30 wt % of the hydrophilically-modified silica nanoparticle solids.

An example magenta inkjet ink composition was prepared with the hydrophobic silica dispersion. This example inkjet ink composition is referred to as Example Ink 1.

A comparative magenta inkjet ink composition was prepared with the hydrophilic silica dispersion. This comparative example inkjet ink composition is referred to as Comp. Example Ink 2.

A control magenta inkjet ink composition was prepared without either the hydrophobic or hydrophilic silica dispersions. This control inkjet ink composition is referred to as Control Ink 3.

The general formulation of each of these inkjet inks is shown in Table 1, with the wt % active of each component that was used. For example, the weight percentage of the pigment dispersion represents the total pigment solids (i.e., wt % active pigment) present in the final ink formulations. In other words, the amount of the pigment dispersion added to the ink compositions was enough to achieve a pigment solids level equal to the given weight percent. Similarly, the weight percentage of the hydrophobic or hydrophilic silica dispersions represents the total nanoparticle solids (i.e., wt % active modified silica nanoparticles) present in the final ink formulations. Additionally, a 5 wt % potassium hydroxide aqueous solution was added to each of the ink compositions until a pH ranging from 8.5 to 9.0 was achieved.

TABLE 1

| | | Ex. | Comp. Ex. | Control |
|---|---|---|---|---|
| | | Ink 1 | Ink 2 | Ink 3 |
| Ingredient | Specific Component | (wt %) | (wt %) | (wt %) |
| Silica | Hydrophobic silica | 4 | — | — |
| Dispersion | dispersion A | | | |
| | Hydrophilic silica | — | 4 | — |
| | dispersion | | | |
| Non-modified | SNOWTEX ® ZL from | 3 | 3 | 3 |
| silica | Nissan Chemical | | | |
| nanoparticles | SNOWTEX ® 30HL | — | — | 4 |
| | from Nissan | | | |
| | Chemical | | | |
| Colorant | CAB-O-JET ® 465M | 4.5 | 4.5 | 4.5 |
| | Dye | 0.5 | 0.5 | 0.5 |
| Co-solvent | 2-pyrrolidone | 15 | 15 | 15 |
| Sugar Alcohol | Sorbitol | 5 | 5 | 5 |
| | Xylitol | 4 | 4 | 4 |
| | Erythritol | 2.5 | 2.5 | 2.5 |
| | Mannitol | 1 | 1 | 1 |
| Surfactant | SURFADONE ® LP100 | 0.1 | 0.1 | 0.1 |
| Organic Acid | Phthalic Acid | 0.25 | 0.25 | 0.25 |
| Water | Deionized water | Balance | Balance | Balance |

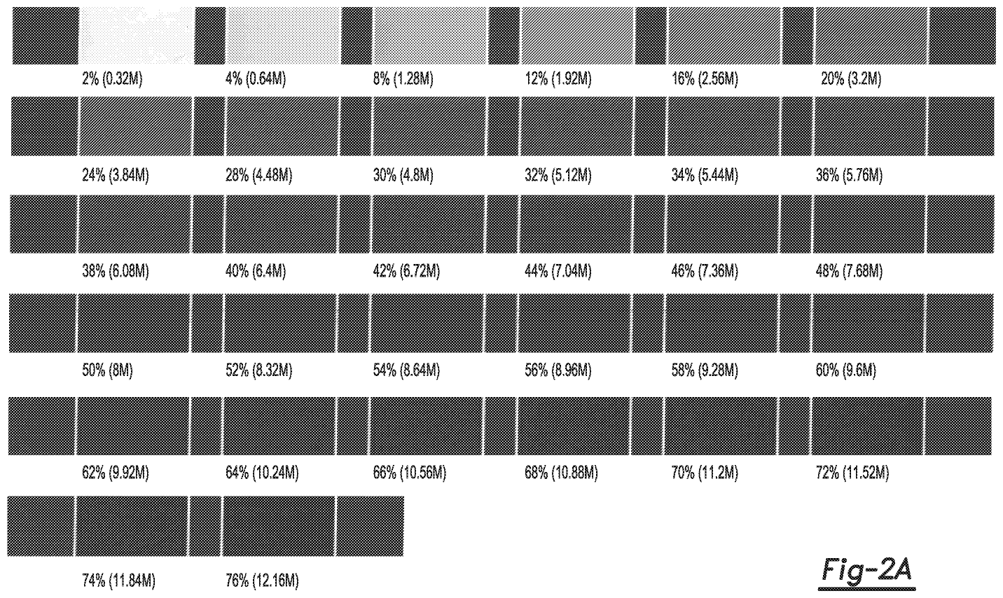

The example, comparative, and control magenta inks were printed on enhanced paper (STERLING® Ultra Gloss (offset coated media)) as square blocks with different levels of ink deposited based on the print mode. The rectangular blocks printed between square blocks were warm-up blocks. FIG. 2A is a black and white reproduction of an originally colored image of the blocks printed with Example Ink 1. FIG. 2B is a black and white reproduction of an originally colored image of the blocks printed with Comp. Example ink 2. FIG. 2C is a black and white reproduction of an originally colored image of the blocks printed with Control Ink 3. In each of these figures, the level (fill density) of ink printed in each of the blocks is represented as a percentage (2%, 4%, 8% . . . 76%), and as the number of drops printed in a pixel (0.32M, 0.64M, 1.28M . . . 12.16M). As an example, 5.12M refers to 5.12 magenta drops per given pixel.

Coalescence appears as fine white marks (e.g., dots, streaks, etc.) on the printed blocks, especially when less ink is printed. When comparing FIG. 2A with both FIG. 2B and FIG. 2C, Example Ink 1 (containing the hydrophobically-modified silica nanoparticle) exhibited improved (reduced) coalescence on the enhanced media relative to Comp. Example Ink 2 and Control ink 3. Moreover, when comparing FIG. 2B and FIG. 2C, Comp. Example Ink 2 (containing the hydrophilically-modified silica nanoparticle) exhibited worse (e.g., more) coalescence on the enhanced media relative to Control Ink 3. These results indicate the hydrophilically-modified silica nanoparticles had the opposite effect as the hydrophobically-modified silica nanoparticles in terms of coalescence.

Example Ink 1 and Control Ink 3 were also printed on three different types of plain paper, namely Hammermill Great White 30 (referred to as “GW30”), Georgia-Pacific Spectrum Multipurpose paper (referred to as “GP Spec), and BOISE® Offset Smooth (referred to as “Boise Smooth”). The levels (fill densities) of each printed ink included 40%, 44%, and 48%.

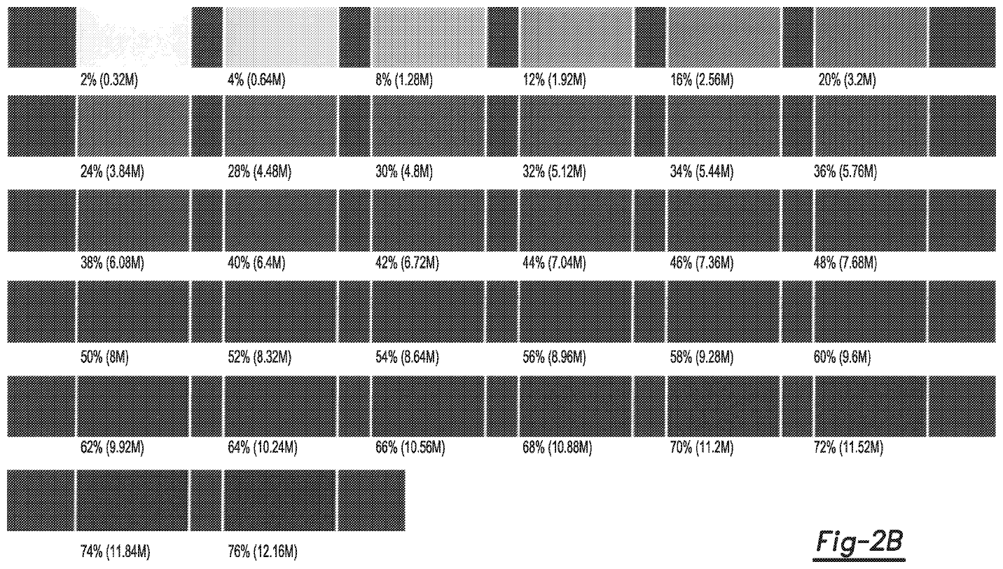

The color saturation of each printed image was measured using an EXACT™ spectrophotometer, from X-Rite Pantone. The color saturation results for Example Ink 1 and Control Ink 3 at the different fill densities on the different papers are shown in FIG. 3. As shown in FIG. 3, Example Ink 1 (including both hydrophobically-modified silica nanoparticles and non-modified silica nanoparticles) exhibited better color saturation results on each of the plain papers than Control Ink 3 (including non-modified silica nanoparticles). Both of the inks exhibited an upward trend in color saturation as the fill density increased on the plain papers.

The results in this example illustrate that the combination of non-modified silica nanoparticles and hydrophobically-modified silica nanoparticles synergistically improve print performance across various printing media.

### Example 2

Another example of hydrophobically-modified silica nanoparticles was prepared. The hydrophobic silane coupling agent used to prepare the hydrophobically-modified silica nanoparticles was Trimethylsiloxytrichlorosilane.

A silica dispersion in isopropyl alcohol was used. The average particle size of the silica in the dispersions ranged from 10 nm to 20 nm. The dispersion was diluted with toluene until a solution with 5 wt % silica was achieved.

Trimethylsiloxytrichlorosilane (the hydrophobic silane coupling agent) was added to one of the silica/toluene solutions at a weight ratio of 1:4, and was stirred at 80° C. for 10 hours. The solids from this mixture were collected and washed with hexanes yielding hydrophobically-modified silica nanoparticles. The hydrophobically-modified silica nanoparticle solids were allowed to dry under vacuum at 100° C. overnight to remove any residual organic solvents.

A hydrophobic silica dispersion (referred to as “hydrophobic silica dispersion B”) was prepared by mixing the hydrophobically-modified silica nanoparticle solids in 50:50 solvent mixture of water:2 pyrrolidone. The final dispersion included about 30 wt % of the hydrophobically-modified silica nanoparticle solids.

An example magenta inkjet ink composition was prepared with this hydrophobic silica dispersion. This example inkjet ink composition is referred to as Example Ink 4.

Another control magenta inkjet ink composition was prepared without the hydrophobic dispersion. This control inkjet ink composition is referred to as Control Ink 5.

The general formulation of each of these inkjet inks is shown in Table 2, with the wt % active of each component that was used. A 5 wt % potassium hydroxide aqueous solution was added to each of the ink compositions until a pH ranging from 8.5 to 9.0 was achieved.

TABLE 2

| | | Ex. | Control |
|---|---|---|---|
| | | Ink 4 | Ink 5 |
| Ingredient | Specific Component | (wt %) | (wt %) |
| Silica Dispersion | Hydrophobic silica | 1-2 | — |
| | dispersion B | | |
| Non-modified silica | SNOWTEX ® ZL from | 1-2 | 3 |
| nanoparticles | Nissan Chemical | | |
| | SNOWTEX ® 30HL from | 4 | 4 |
| | Nissan Chemical | | |
| Colorant | CAB-O-JET ® 465M | 4.5 | 4.5 |
| | Dye | 0.5 | 0.5 |
| Co-solvent | 2-pyrrolidone | 15 | 15 |
| Sugar Alcohol | Sorbitol | 5 | 5 |
| | Xylitol | 4 | 4 |
| | Erythritol | 2.5 | 2.5 |
| | Mannitol | 1 | 1 |
| Surfactant | SURFADONE ® LP100 | 0.1 | 0.1 |
| Organic Acid | Phthalic Acid | 0.25 | 0.25 |
| Water | Deionized water | Balance | Balance |

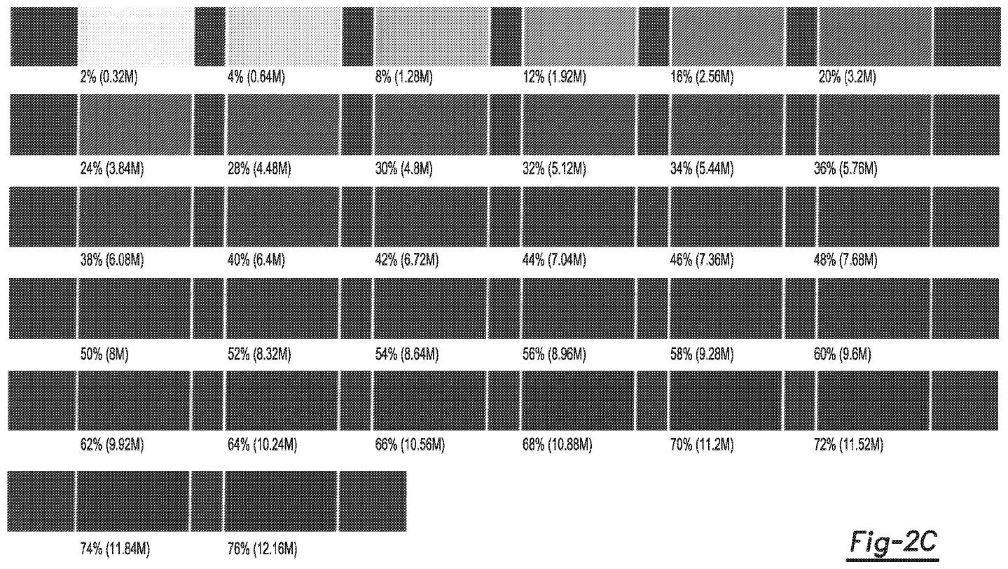

These example and control magenta inks were printed on enhanced paper (STERLING® Ultra Gloss (offset coated media)) as rectangle blocks with different levels of ink deposited based on the print mode. FIG. 4A is a black and white reproduction of an originally colored image of the blocks printed with Example Ink 4. FIG. 4B is a black and white reproduction of an originally colored image of the blocks printed with Control Ink 5. In each of these figures, the level (fill density) of ink printed in each of the blocks is represented as a percentage (41% or 47%).

As noted herein, coalescence appears as fine white marks (e.g., dots, streaks, etc.) on the printed blocks. When comparing FIG. 4A with FIG. 4B, Example Ink 4 (containing the hydrophobically-modified silica nanoparticle) exhibited improved (reduced) coalescence on the enhanced media relative to Control ink 5.

Example Ink 4 and Control Ink 5 were also printed on enhanced paper (STERLING® Ultra Gloss (offset coated media) and on plain paper, namely STAPLES copy paper to test for color saturation. The levels (fill densities) of each printed ink included 25%, 30%, 40%, 45%, and 50%.

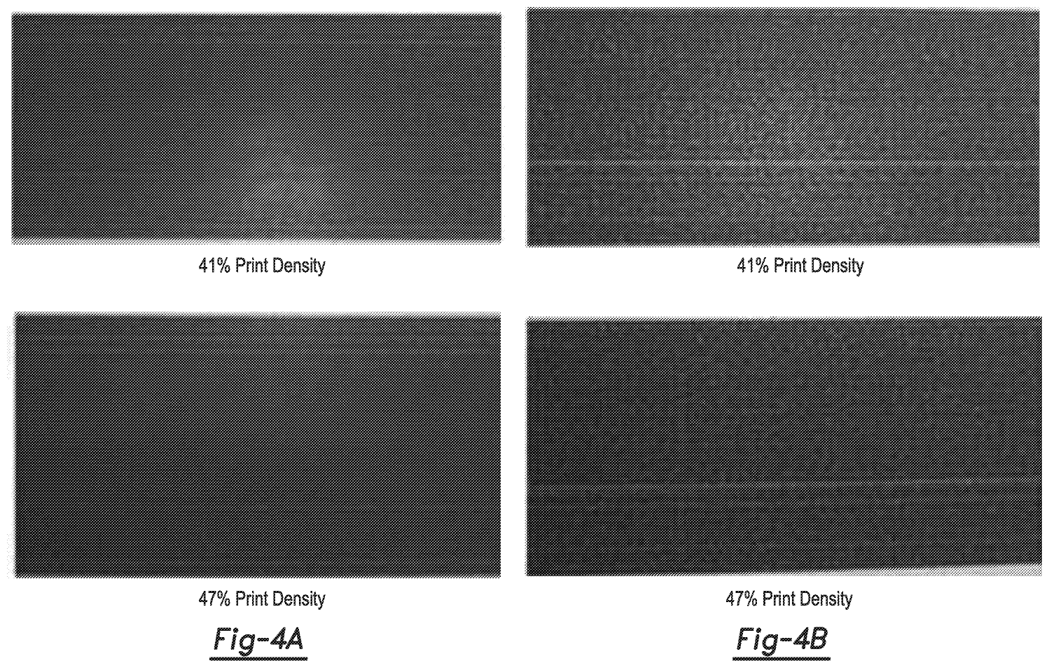

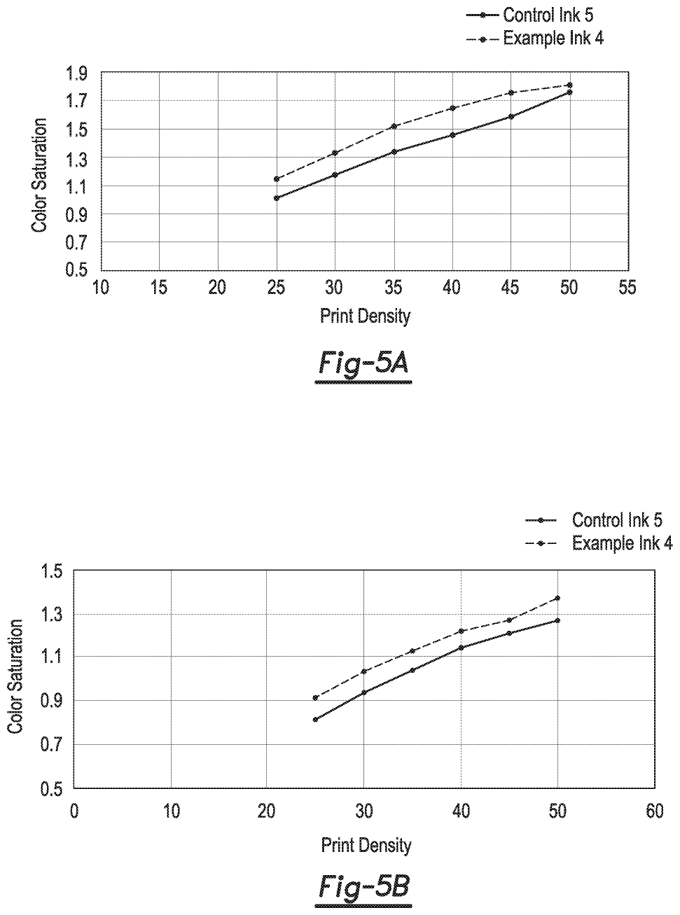

The color saturation of each printed image on the enhanced paper and on the plain paper was measured using an EXACT™ spectrophotometer, from X-Rite Pantone. The color saturation results for Example Ink 4 and Control Ink 5 on the enhanced paper at the different fill densities are shown in FIG. 5A, and the color saturation results for Example Ink 4 and Control Ink 5 on the plain paper at the different fill densities are shown in FIG. 5B. As shown in both FIG. 5A and FIG. 5B, Example Ink 4 (including both hydrophobically-modified silica nanoparticles and non-modified silica nanoparticles) exhibited better color saturation results than Control Ink 5 (including non-modified silica nanoparticles) on the enhanced paper and on the plain paper. Both of the inks exhibited an upward trend in color saturation as the fill density increased on the respective papers.

The results in this example illustrate that the combination of non-modified silica nanoparticles and hydrophobically-modified silica nanoparticles synergistically improve print performance across various printing media.

It is to be understood that the ranges provided herein include the stated range and any value or sub-range within the stated range, as if such values or sub-ranges were explicitly recited. For example, a range from about 0.01 wt % actives to about 10 wt % actives should be interpreted to include not only the explicitly recited limits of from about 0.01 wt % actives to about 10 wt % actives, but also to include individual values, such as 0.75 wt % actives, 1.25 wt % actives, 7 wt % actives, 9.5 wt % actives, etc., and sub-ranges, such as from about 0.55 wt % actives to about 3.75 wt % actives, from about 1 wt % actives to about 8 wt % actives, etc. Furthermore, when “about” is utilized to describe a value, this is meant to encompass minor variations (up to +/−10%) from the stated value.

Reference throughout the specification to “one example”, “another example”, “an example”, and so forth, means that a particular element (e.g., feature, structure, and/or characteristic) described in connection with the example is included in at least one example described herein, and may or may not be present in other examples. In addition, it is to be understood that the described elements for any example may be combined in any suitable manner in the various examples unless the context clearly dictates otherwise.

In describing and claiming the examples disclosed herein, the singular forms “a”, “an”, and “the” include plural referents unless the context clearly dictates otherwise.

While several examples have been described in detail, it is to be understood that the disclosed examples may be modified. Therefore, the foregoing description is to be considered non-limiting.

What is claimed is:

1. An inkjet ink composition, comprising:
an aqueous vehicle;
a colorant dispersed or dissolved in the aqueous vehicle;
silica nanoparticles dispersed in the aqueous vehicle; and
modified silica nanoparticles dispersed in the aqueous vehicle, each modified silica nanoparticle including:
a silica core; and
a hydrophobic silane coupling agent attached to the silica core.

2. The inkjet ink composition as defined in claim 1 wherein a weight ratio of the hydrophobic silane coupling agent to the silica core ranges from about 1:4 to about 1:40.

3. The inkjet ink composition as defined in claim 1 wherein the hydrophobic silane coupling agent is selected from the group consisting of butyltrichlorosilane, methyltrichlorosilane, benzyltrichlorosilane, trimethylsiloxytrichlorosilane, bis(trimethylsiloxy)dichlorosilane, butyldimethylchlorosilane, dioctyldichlorosilane, diethyldichlorosilane, allylphenyldichlorosilane, allyl(3-chloropropyl)dichlorosilane, (S,S)-2-allyl-2-chloro-3,4-dimethyl-5-phenyl-[1,3,2]-oxazasilolidine, and combinations thereof.

4. The inkjet ink composition as defined in claim 1 wherein:
the silica nanoparticles are present in an amount ranging from about 0.5 wt % active to about 6 wt % active based on a total weight of the inkjet ink composition; and
the modified silica nanoparticles are present in an amount ranging from about 0.5 wt % active to about 6 wt % active based on the total weight of the inkjet ink composition.

5. The inkjet ink composition as defined in claim 1, further comprising a sugar alcohol, an organic acid, or combinations thereof.

6. The inkjet ink composition as defined in claim 1 wherein the colorant is a pigment, a dye, or a combination thereof.

7. The inkjet ink composition as defined in claim 6 wherein the colorant includes a magenta pigment and a magenta dye.

8. The inkjet ink composition as defined in claim 1 wherein the aqueous vehicle includes an organic co-solvent, a surfactant, and water.

9. An inkjet printing kit, comprising:
a recording medium; and
an inkjet ink composition, including:
an aqueous vehicle;
a colorant dispersed or dissolved in the aqueous vehicle;
silica nanoparticles dispersed in the aqueous vehicle; and
modified silica nanoparticles dispersed in the aqueous vehicle, each modified silica nanoparticle including:
a silica core; and
a hydrophobic silane coupling agent attached to the silica core.

10. The inkjet printing kit as defined in claim 9 wherein the recording medium is enhanced paper or plain paper.

11. The inkjet printing kit as defined in claim 9 wherein a weight ratio of the hydrophobic silane coupling agent to the silica core ranges from about 1:4 to about 1:40.

12. The inkjet printing kit as defined in claim 9 wherein the hydrophobic silane coupling agent is selected from the group consisting of butyltrichlorosilane, methyltrichlorosilane, benzyltrichlorosilane, trimethylsiloxytrichlorosilane, bis(trimethylsiloxy)dichlorosilane, butyldimethylchlorosilane, dioctyldichlorosilane, diethyldichlorosilane, allylphenyldichlorosilane, allyl(3-chloropropyl)dichlorosilane, (S,S)-2-allyl-2-chloro-3,4-dimethyl-5-phenyl-[1,3,2]-oxazasilolidine, and combinations thereof.

13. The inkjet printing kit as defined in claim 9 wherein:
the silica nanoparticles are present in the inkjet ink composition in an amount ranging from about 0.5 wt % active to about 6 wt % active based on a total weight of the inkjet ink composition; and
the modified silica nanoparticles are present in the inkjet ink composition in an amount ranging from about 0.5 wt % active to about 6 wt % active based on the total weight of the inkjet ink composition.

14. A printing method, comprising:
inkjet printing an inkjet ink composition onto a recording medium, the inkjet ink composition including:
an aqueous vehicle;
a colorant dispersed or dissolved in the aqueous vehicle;
silica nanoparticles dispersed in the aqueous vehicle; and
modified silica nanoparticles dispersed in the aqueous vehicle, each modified silica nanoparticle including:
a silica core; and
a hydrophobic silane coupling agent attached to the silica core.

15. The printing method as defined in claim 14 wherein the recording medium is enhanced paper or plain paper.
